(19) United States
(12) Patent Application Publication
(10) Pub. No.: US 2006/0133909 A1
(43) Pub. Date: Jun. 22, 2006

(54) Keeper paddle

(75) Inventors: Daniel Jimenez, Longview, TX (US); Bill Sphatt, Longview, TX (US)

Correspondence Address: KILPATRICK STOCKTON LLP, 1001 WEST FOURTH STREET, WINSTON-SALEM, NC, 27101, US

(73) Assignee: Stemco LP

(21) Appl. No.: 11/312,667

(22) Filed: Dec. 20, 2005

Related U.S. Application Data
(60) Provisional application No. 60/637,916, filed on Dec. 21, 2004.

(51) Int. Cl. F16B 39/10

(52) U.S. Cl. 411/204

(57) ABSTRACT

The present invention relates to a lock ring having a central body portion with a first end and second end with two legs extending radially from the first end and the second end of the central body portion, wherein each of the two legs has a first axially biased portion and a second axially biased portion relative to a position of the central body portion. Alternative embodiments of the lock ring of the present invention include the lock ring in conjunction with the first axially biased portion and the second axially biased portion being disposed in the same direction, tabs on the central body portion, teeth on the lock ring for engaging corresponding teeth in an annular groove in a lock nut, and a rounded portion at each of the distal ends of the legs. The present invention also relates to an assembly containing the lock ring of the present invention in conjunction with the lock nut as well as methods for preventing the counter-rotation of nuts and/or bolts.

This application claims priority under 35 U.S.C. §119(e) to U.S. provisional application No. 60/637,916 filed Dec. 21, 2004, the entire contents of which are incorporated by reference in its entirety.

### FIELD OF THE INVENTION

The present invention relates to couplings and more particularly to lock rings and lock nut assemblies for preventing reverse rotation and displacement of nuts and/or bolts. Moreover, the present invention is directed to methods of preventing the counter rotation of assemblies of nuts, lock rings and/or bolts using the embodiments of the present invention.

### BACKGROUND OF THE INVENTION

Lock rings are employed to prevent counter-rotation of nuts. In a typical construction, the bolt is provided with an annular groove extending axially into the head of the bolt, a lock nut is provided with an annular locking mechanism (lock ring) having an inwardly extending key. The locking mechanism extends over the bolt shaft with the key extending into the axial groove. The locking mechanism is also provided with means for engaging the lock nut to prevent the lock nut from turning on the bolt shaft.

While the basic design of a lock ring had changed little, there is a problem with the original design that has heretofore not been improved upon. A common split lock ring design is discussed in U.S. Pat. No. 3,844,323 ('323 patent) entitled “Split Lock Ring”, and hereby incorporated by reference. The '323 patent provides a lock ring adapted to be disposed and secured within an undercut cavity formed in the main body of the lock nut. The lock nut is provided with an annular groove cut into the radially inner surface of an inner face thereof. An annular set of teeth is mounted about the periphery of the lower portion of the side wall adjacent to the bottom wall of the groove. The lock ring comprises a split ring having a central body portion and a pair of legs extending radially outwardly therefrom. The central body portion includes an inwardly extending key and an outwardly extending projection, and a pair of sections having a plurality of teeth formed on a radially outer periphery thereof. The key is adapted to extend into the undercut while the teeth are adapted to engage a portion of the teeth formed in the cavity to lock the ring against rotation with the nut. The central body portion of the lock ring is secured in position by the legs of the lock ring extending into the undercut groove. Besides being biased outwardly to engage the sidewall of the undercut groove, the lock ring legs are biased in the axial direction to cause the upper surface of the legs to be biased against the upper wall, and the central body portion of the ring to be biased against the bottom surface of the cavity, thereby ensuring that the lock ring remains secure and in contact with the teeth in the cavity without becoming dislodged.

While this design has enjoyed much commercial success, there is a danger that the ring will be installed in the lock nut upside-down which results in improper alignment between the lock ring and the lock nut. When this occurs, the nut can be tightened. However without proper alignment and engagement of the teeth on the lock ring and the teeth on the lock nut, the lock nut will be allowed to rotate independently of the lock ring, due to failure to prevent counter-rotation of the nut.

Thus, there is a need for a split lock ring comprising a feature to prevent improper installation and ensure that the teeth of the lock ring are securely engaged with the teeth on the lock nut. It is with this idea in mind that the embodiments of the instant invention were developed.

### BRIEF DESCRIPTION OF THE DRAWINGS

FIG. 1 is a side view of a lock nut with the lock ring protruding from the top of the groove in an embodiment of the present invention. In this figure an improperly installed lock ring is illustrated; the axially biased leg portions (left side) will prevent the lock ring from seating properly or improperly within the groove, so there is no perception of a correctly installed lock ring when it is in fact not correctly installed. Accordingly, it will be apparent immediately when the lock ring is in fact incorrectly installed.

FIG. 2 is a top view of a lock nut with the lock ring inserted properly in an embodiment of the present invention.

FIG. 3 is a perspective view of the lock ring according to an embodiment of the present invention.

FIG. 4a is a side view of a lock nut with a lock ring according to the prior art.

FIG. 4b is a side view of a lock nut with a lock ring according to an embodiment of the present invention.

FIG. 5a is a perspective view of a lock ring according to the prior art.

FIG. 5b is a perspective view of a lock ring according to an embodiment of the present invention.

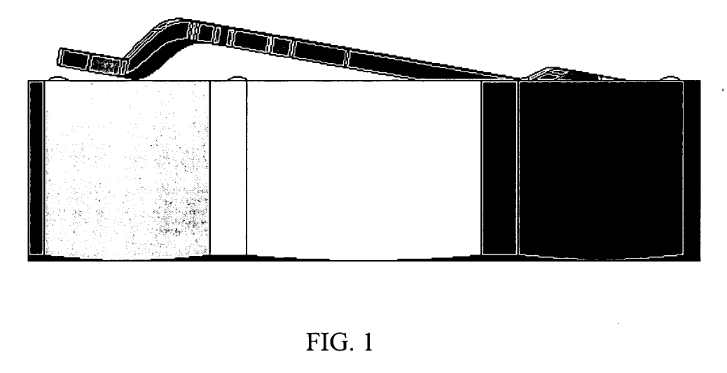

### SUMMARY OF THE INVENTION

The present invention provides a physical feature to prevent improper installation of the lock ring into the lock nut. With this feature, the lock ring can not be installed backwards.

In an embodiment of the present invention, the means for preventing improper installation comprises an axially biased portion of the end portion (distal portion) of the legs. This axially biased portion will interfere with the bottom surface of the radial groove on the lock nut if one attempts to install the lock ring incorrectly. Installed correctly, the axially biased portions will extend away from the bottom surface of the radial groove thereby allowing the lock ring to properly engage the groove in the lock nut.

In another embodiment of the present invention, the distal end of the axially biased portion of the legs is formed into a circular shape, with at least a portion of the shape extending radially over the wall of the groove in the lock nut.

Referring now to FIG. 3, illustrating a lock ring according to a preferred embodiment of the present invention, the lock ring 10 contains several features common to such devices. The lock ring 10 comprises a central body portion 20 that includes tabs extending radially inward and outward for engaging the axle and lock nut respectively. Further provided on the central body portion 20 are a plurality of teeth 22, which engage a corresponding set of teeth within the groove on the lock nut. Two legs 24 extend from either end of the central body portion 20 and terminate at a distal end. The legs 24 are biased 26 axially from the central body portion 20 of the ring. At the distal ends of the legs, an additional axial bias 30 in the same direction of the first axial bias 26 comprises the installation and means of the present invention. Further provided are rounded distal ends 32 of the legs which further aid in proper installation of the lock ring by providing additional physical interference with the lock nut when one attempts to install the ring improperly.

### DETAILED DESCRIPTION OF THE INVENTION

One embodiment of the invention is a lock ring comprising a central body portion having a first end and second end with two legs extending radially from said first end and said second end of the central body portion, wherein each of said two legs has a first axially biased portion and a second axially biased portion relative to a position of the central body portion. In an optional embodiment, the first axially biased portion and the second axially biased portion form planes that are substantially parallel to each other, which in turn are substantially parallel to the plane of the central body portion. In an embodiment the central body portion may be substantially in the same plane as the second axially biased portion or alternatively, all of the planes (i.e., the central body portion plane, the first axially biased portion and the second axially biased portion) may be in different planes.

In an alternate embodiment, the first axially biased portion and the second axially biased portion are axially biased in the same direction. In this embodiment, all of the planes (although substantially parallel) are in different planes.

In an alternate embodiment, the lock ring comprises tabs that extend radially inward and outward from the central body portion, the tabs designed for engaging an axle and a lock nut respectively. The axle in an embodiment is associated with a bolt so that the tabs that extend radially inward and outward from the central body portion engage the bolt and the nut so that the nut and bolt remain fixedly positioned so as to prevent displacement and or counter rotation of the nut and or bolt relative to each other.

In an alternate embodiment, the lock ring comprises a plurality of teeth for engaging a corresponding plurality of teeth on a groove in a lock nut. The plurality of teeth on the lock nut engage the corresponding plurality of teeth on a groove in the lock nut so that the lock ring remains fixedly positioned relative to the position of the lock nut.

In an alternate embodiment, the lock ring comprises a proximal end and a distal end of each of the two legs extending radially from said first end and said second end of the central body portion, wherein the first axially biased portion is in the proximal end of the two legs and the second axially biased portion is in the distal end of the two legs. Alternatively, the first axially biased portion and the second axially biased portion may both be at the proximal end of each of the legs or at the distal end of each of the legs.

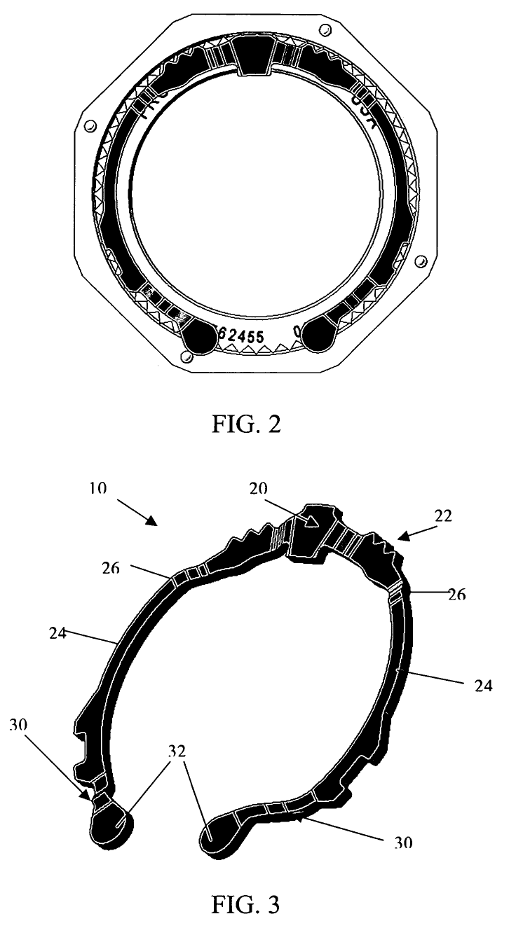

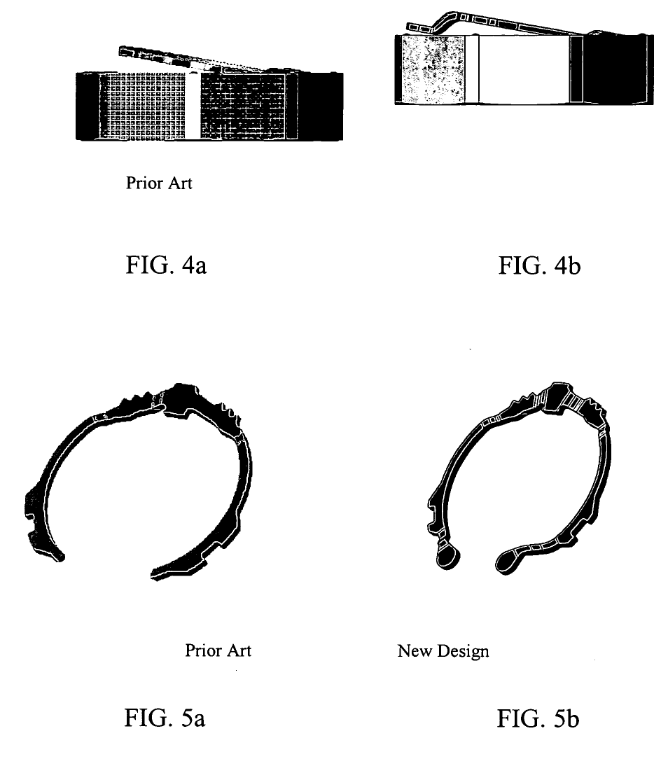

In an alternate embodiment, the lock ring comprises a rounded portion at the distal end of the two legs. The rounded portion may fit into the annular groove of the lock nut when the lock ring is fixedly positioned relative to the lock nut or alternatively, the rounded portion may sit outside of the annular groove of the lock nut. The rounded portion sitting outside of the annular groove of the lock nut is shown in FIG. 2.

In an alternate embodiment, the lock ring is part of an assembly that contains a lock nut associated with the lock ring and a bolt.

In an alternate embodiment of the assembly, the lock ring comprises a rounded portion at the distal end of the two legs that is not in a groove in the lock nut when the lock nut, the lock ring and the bolt of the assembly are all fixedly positioned relative to each other.

In an alternate embodiment, the present invention is directed to a lock ring adapted for use in a lock nut assembly with the lock ring having a central body portion containing radially inwardly and outwardly tabs, the outwardly tab designed to engage a keyway in an annular groove in the lock nut and the radially inward tab designed to engage an axle on a bolt, thereby preventing the displacement or counter rotation of a bolt relative to a nut in the lock nut assembly; the central body portion having a first end and a second end with two legs extending radially from said first end and said second end of the central body portion, wherein each of said two legs has a first axially biased portion and a second axially biased portion parallel to but not in the same plane as the plane of the central body portion of the lock ring. The lock ring of this embodiment optionally has the first axially biased portion and the second axially biased portion oriented in the same direction. Moreover, the lock ring of this embodiment optionally further has one or more sections containing a plurality of teeth projecting radially outward to engage teeth that project radially inwards from the annular groove in the lock nut. Further, the lock ring of this embodiment optionally has a rounded portion at the distal end of each of the two legs wherein when the lock ring is in position so that displacement or counter rotation of a bolt relative to a nut in the assembly does not occur, the rounded portion can reside in the annular groove of the nut, or optionally, outside of the groove of the nut.

In an alternate embodiment, the invention is directed to methods of preventing the counter-rotation of nuts and/or bolts using the lock ring embodiments described above.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments all of which are considered to be within the scope of the present invention. Accordingly, the description herein should not be read as limiting the present invention, as other embodiments also fall within the scope of the present invention.

Moreover, it should be understood that a plurality of elements have been described in the above written description. It is contemplated and therefore within the scope of the invention that any one or more of these plurality of elements can be combined with any one or more of these plurality of elements to generate an embodiment of the present invention. Thus, the present invention is not to be limited by the foregoing description but rather is to be defined by the following claims.

We claim:

1. A lock ring comprising a central body portion having a first end and second end with two legs extending radially from said first end and said second end of the central body portion, wherein each of said two legs has a first axially biased portion and a second axially biased portion relative to a position of the central body portion.

2. The lock ring of claim 1, wherein the first axially biased portion and the second axially biased portion are axially biased in a same direction.

3. The lock ring of claim 1, further comprising tabs that extend radially inward and outward from the central body portion, the tabs designed for engaging an axle and a lock nut respectively.

4. The lock ring of claim 1, further comprising a plurality of teeth for engaging a corresponding plurality of teeth on a groove in a lock nut.

5. The lock ring of claim 2, further comprising a plurality of teeth for engaging a corresponding plurality of teeth on a groove in a lock nut.

6. The lock ring of claim 2, further comprising a proximal end and a distal end of each of the two legs extending radially from said first end and said second end of the central body portion, wherein the first axially biased portion is in the proximal end of the two legs and the second axially biased portion is in the distal end of the two legs.

7. The lock ring of claim 6, further comprising a rounded portion at each of the distal ends of the two legs.

8. The lock ring of claim 1, further comprising a proximal end and a distal end of each of the two legs extending radially from said first end and said second end of the central body portion, with a rounded portion at the distal end of the two legs.

9. The lock ring of claim 7, further comprising a lock nut associated with the lock ring.

10. The lock ring of claim 9, further comprising a plurality of teeth for engaging a corresponding plurality of teeth on a groove in a lock nut.

11. The lock ring of claim 9, wherein the rounded portion at the distal end of the two legs is not in a groove in the lock nut.

12. The lock ring of claim 10, wherein the rounded portion at the distal end of the two legs is not in a groove in the lock nut.

13. A lock ring comprising a central body portion having a first end and second end with two legs extending radially from said first end and said second end of the central body portion, wherein said central body portion and said legs have a first axially biased portion and a second axially biased portion relative to a position of the central body portion, wherein the first axially biased portion and the second axially biased portion are axially biased in a same direction with tabs that extend radially inward and outward from the central body portion, the tabs designed for engaging an axle and a lock nut respectively.

14. The lock ring of claim 13, further comprising a plurality of teeth for engaging a corresponding plurality of teeth on a groove in a lock nut.

15. The lock ring of claim 13, further comprising a plurality of teeth for engaging a corresponding plurality of teeth on a groove in a lock nut.

16. The lock ring of claim 13, further comprising a proximal end and a distal end of each of the two legs extending radially from said first end and said second end of the central body portion, wherein the first axially biased portion is in the proximal end of the two legs and the second axially biased portion is in the distal end of the two legs.

17. The lock ring of claim 16, further comprising a rounded portion at each of the distal ends of the two legs.

18. The lock ring of claim 13, further comprising a proximal end and a distal end of each of the two legs extending radially from said first end and said second end of the central body portion, with a rounded portion at the distal end of the two legs.

19. The lock ring of claim 17, further comprising a lock nut associated with the lock ring.

20. The lock ring of claim 19, further comprising a plurality of teeth for engaging a corresponding plurality of teeth on a groove in a lock nut.
